(19) United States
(12) Patent Application Publication
(10) Pub. No.: US 2006/0089943 A1
(43) Pub. Date: Apr. 27, 2006

(54) Computer system and process for aiding in an outsourcing environment

(75) Inventors: Christopher Creel, Tampa, FL (US); Joe R. Bengfort, Grapevine, TX (US); Richard Wyman, Plano, TX (US)

Correspondence Address: JENKENS & GILCHRIST, PC, 1445 ROSS AVENUE, SUITE 3200, DALLAS, TX, 75202, US

(73) Assignee: Perot Systems Corporation

(21) Appl. No.: 10/973,111

(22) Filed: Oct. 25, 2004

(51) Int. Cl. G06F 17/00

(52) U.S. Cl. 707/102

(57) ABSTRACT

A method for utilizing an enterprise description language for describing outsourcing arrangements is disclosed. Also disclosed is an exemplary enterprise description language for implementing embodiments of the present invention. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims. 37 CFR 1.72(b).

### BACKGROUND OF THE INVENTION

1. Technical Field

The present invention relates to management of database queries, and more particularly, but not by way of limitation, to utilizing an enterprise description language (EDL) for describing outsourcing arrangements.

2. History of the Related Art

Many businesses are realizing the benefits of outsourcing specific operations to other, more qualified businesses. For example, many businesses are beginning to outsource IT organizations to personnel that have more experience and a better track record of handling IT issues in an appropriate and efficient manner. Other portions of a business, such as business processes, may also be outsourced. Business processes (e.g., claims processing, financials, accounts receivables/payables, etc.) may be outsourced to personnel skilled in that particular area, thereby providing additional benefits and cost savings to the business.

When a business decides to outsource a particular organization, such as the IT organization, the business typically hires a third party to formulate a contract for the outsourcing deal. In most cases, the IT environment is very complex and difficult to describe to the third party, and therefore, the third party typically assesses the IT environment from various data, documents, current IT personnel, etc. The third party concentrates on the hard assets (software, machines, etc.) and may not determine any external factors, such as underlying data, business processes, external vendors, personnel, etc. that may be affected by the outsourced organization, or that the outsourced organization may affect. This “softer” data from personnel tends to be more difficult to convey to a third party than other tangible assets.

Once a team agrees to take over the outsourced organization, the third party instills their knowledge to the team. At this point, the team may be blind-sided by various obstacles, such as unknown relationships between the outsourced organization and other business processes. For example, the team, after winning the contract, may go to the business to create move packages based on the information from the third party. A move package is a set of items (machines, data software, etc.) that may be physically moved from the business location to a data center location of the team. The team may then unknowingly transport a set of data, etc. to the data center which may negatively affect other business processes. For example, the third party may not realize that there is an ad hoc database of contact information for new contracts in a particular move package. When the server including the database is shut down for the move, any user, such as a salesman, does not have access to the database. As such, the third party discovers this database after the server is shut down and the user calls the help desk to complain that the contact information is not available.

### BRIEF SUMMARY OF THE INVENTION

The present invention relates to management of database queries utilizing an enterprise description language. More particularly an embodiment of the present invention relates to a system for aiding in an outsourcing environment. The system comprises an enterprise description language for describing outsourcing arrangements, and a knowledge repository for storing modules related to the outsourcing arrangements and storing data related to relationships between the modules.

In another aspect, the present invention relates to a method for implementing an enterprise description language. The method comprises the steps of correlating client needs to business and technical environment uses, enacting an iteration of the enterprise description language, designing organization segments and related elements according to the iteration, and building organization segments and related elements according to the iteration.

In another aspect, the present invention relates to a system for implementing an enterprise description language. The system comprises means for correlating client needs to business and technical environment uses, means for enacting an iteration of the enterprise description language, means for designing organization segments and related elements according to the iteration, and means for building organization segments and related elements according to the iteration.

### BRIEF DESCRIPTION OF THE DRAWINGS

For a more complete understanding of the present invention, and for further objects and advantages thereof, reference is made to the following description taken in conjunction with the accompanying drawings in which:

FIG. 1A is a block diagram illustrating an EDL in accordance with an embodiment of the present invention;

FIG. 1B is a block diagram of a solution module in accordance with an aspect of the present invention;

FIG. 2 is a is block diagram of a change module in accordance with an aspect of the present invention;

FIG. 3 is a block diagram of a strategy module in accordance with an aspect of the present invention;

FIG. 4 is a block diagram of a change management module in accordance with an aspect of the present invention;

FIG. 5 is a block diagram of a finance module in accordance with an aspect of the present invention;

FIG. 6 is a block diagram of an information module in accordance with an aspect of the present invention;

FIG. 7 is a block diagram of a compliance module in accordance with an aspect of the present invention;

FIG. 8 is a block diagram of a workflow module in accordance with an aspect of the present invention;

FIG. 9 is a block diagram of a business module in accordance with an aspect of the present invention;

FIG. 10 is a block diagram of an operations module in accordance with an aspect of the present invention;

FIG. 11 is a block diagram of an architecture module in accordance with an aspect of the present invention;

FIG. 12A is block diagram of a users and uses module in accordance with an aspect of the present invention;

FIGS. 12B-12L are block diagrams of specific users and uses modules in accordance with an aspect of the present invention; and

FIG. 13 is a flow diagram illustrating a method of implementing embodiments of the present invention.

### DETAILED DESCRIPTION OF THE INVENTION

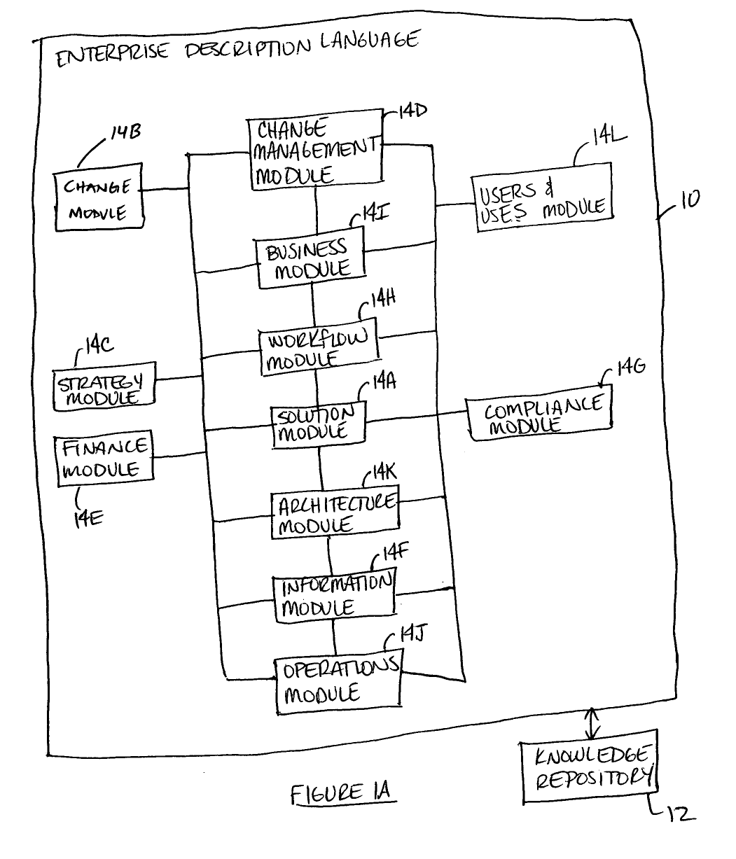

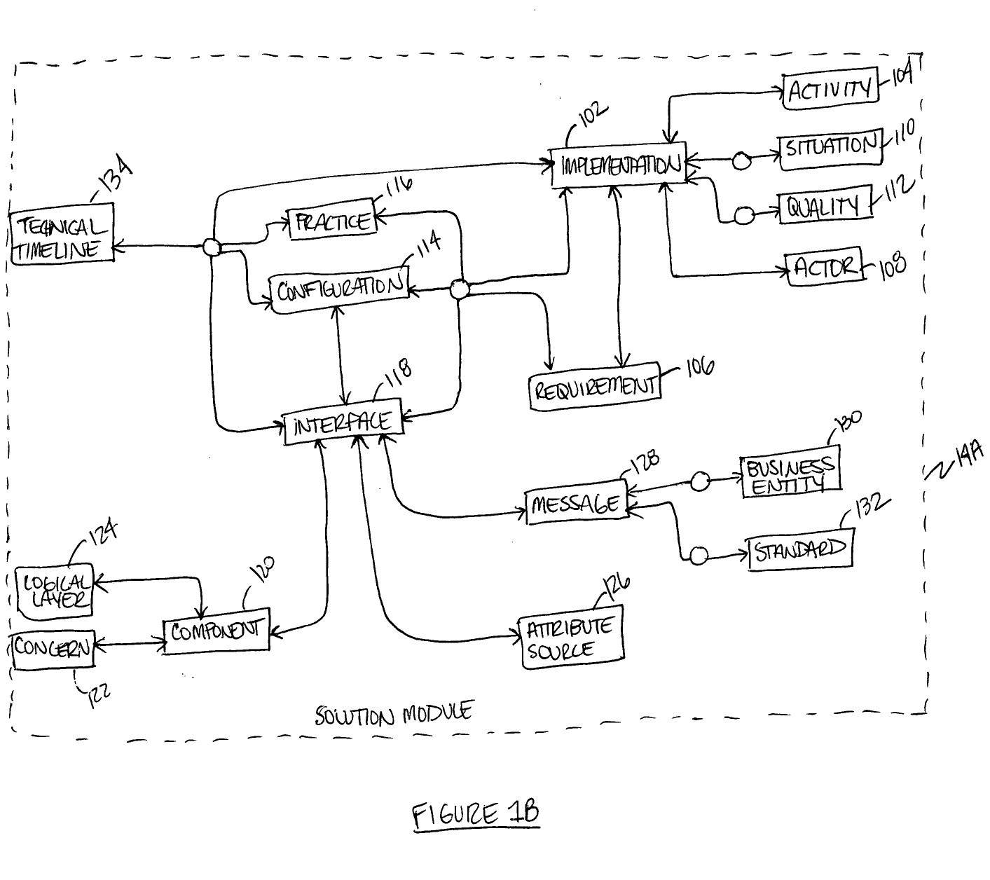

Portions of an organization, such as a company may interact, one with the other, in a myriad of ways. Because of this, accurate modeling of the organization environment (e.g., a business and technical environment) may be extremely complex. Referring now to FIG. 1A, a visualization of an EDL 10 in accordance with an embodiment of the present invention is illustrated. The EDL 10 is a planning tool that provides an organization with corporate transparency that supports better informed decision making. The EDL 10 also aids in the identification of the impact of various decisions throughout various portions of the EDL 10 and numerous portions of the organization. In addition, previously stranded assets may be reused by exposing the assets to a wider audience. The EDL 10 may also generate a wide variety or reports that provide relevant information for tasks such as IT planning decisions, investment decisions, and guiding development efforts. Some specific reports that may be generated by the EDL 10 assess project cost and Return On Investment (ROI), evaluate technology solutions, improve business processes, coordinate training, etc.

Still referring to FIG. 1A, in order to enact various portions of the EDL 10 with respect to a specific organization, a knowledge repository 12 is populated with information relating to and/or gathered from the specific organization desiring to outsource a portion thereof. The knowledge repository 12 is a repository in which information about the organization is captured, organized, and automatically synchronized. The information may be, for example, cataloging of servers, applications, relationships between servers, applications, and business processes. Additional information may include cataloging in-flight projects and the relationship between these projects and the business processes and applications. The captured information allows, for example, business processes to be traced to the technology supporting them. Similarly, the technology is traced to business processes the technology supports. The impact of business strategy on, for example IT, may be realized, and vice versa. The captured information, or relationships determined therefrom, may be supplied to any one, or more, of the modules 14.

In accordance with aspects of the present invention, an EDL 10 is created for efficiently and effectively describing technology and business environments and their relationship to one another. The EDL 10 aids in the specification, visualization, and documentation of software systems, such as those being outsourced, along with interactions between the software systems and other portions of the organization. The EDL 10 may be seen as a bottom-up descriptive method that describes relationships, etc. for the purposes of aligning enterprise activities and information. By utilizing EDL 10, a solution for any number of environments and organizations may be produced from the various modules of the EDL 10 as described below. EDL 10, allows a user to describe a series of actions the user wants a computer to take with a suite of objects. EDL 10 describes these object through combinations of data and behavior. These combinations of data and behavior are visually illustrated with reference to the modules as described below in FIGS. 1B-11.

As set forth above, the business and technical environment of the present invention may be very complex and therefore a two-dimensional model may not adequately describe the EDL 10. As such, the following described Figures illustrate various dimensional views of specific portions, defined as modules 14, of the EDL 10. The modules 14 interconnect, and therefore, may include items that are present in other modules 14 as well. In addition, although the modules 14, as illustrated in FIG. 1B-FIG. 12L, are embodiments for implementing the present invention, various modifications and adaptations may be made without departing from aspects and features of the present invention. For example, the EDL 10 is dynamic and flexible. In other words, as an organization expands or changes, the modules 14 may expand or change as well.

Referring now to FIG. 1B, a block diagram of a solution module 14A of the EDL 10 is illustrated. The solution module 14A is a visualization of the EDL that represents the amalgamation of solutions employed in order to successfully execute an organization's activities in accordance with specified requirements. The solution module 14A includes an implementation 102 which is a means by which activities 104 are successfully completed in accordance with specified requirements 106. An activity 104 is some action taken in the course of executing a business process or a support process, that in some way moves the process forward. As such, an activity 104 can be seen as a step in a business process. The level of detail of the activity 104 is sufficient to the extent that it reveals architecturally significant details as defined in the business process or support process definition. An activity 104 minimally represents a single unit of work and to the extent that it identifies existing technology or the potential use of technology. For example, an activity 104 may be an admissions process for patients within a hospital and related technology that the hospital employees use to admit the patients. According to an exemplary embodiment, an implementation 102 is a mix of manual processes and technologies that the employees use at each step in the business process. However, if the technologies and manual practices are effectively the same for each activity (e.g., the application is used for all the activities in the business process) then there are no architecturally significant details worth describing by delving into activities and so the description remains at the business process level.

Still referring to FIG. 1B, also interacting with the implementation 102 are requirements 106 and actors 108. A requirement 106 is a behavioral or non-behavioral requirement of the implementation 102 that is necessary to successfully complete the activity 104. For example, a requirement 106 may be a need to identify previous visits to satellite clinics during the admissions process or outstanding bills from visits to satellite clinics. An actor 108 is a role, or set of skills applied by a person that executes the activity 104 for the purpose of realizing an expected business value. A situation 110 and a quality 112 are also indirectly related to the implementation 102. The situation 110 is a set of circumstances under which the implementation 102 or data source is valid. In other words, the item is dependent on a specific situation, where circumstances describe the facets of the situation 110. For example, a situation 110 may define a set of circumstances under which a process deviates “normal” as may be the case with admitting patients that are high profile (e.g., celebrities, politicians) or have security concerns (e.g., prisoners). In such cases, a separate system may be required in order to capture specialized information that the primary system is incapable of handling. The quality 112 defines items that serve as additional dimensions of definition that cut across many different items within a business and technical environment. Such cross cutting concerns include standards, principles, exhibited qualities (and their measurements), and situations that arise that force fractures in the business and technical environment. Qualities 112 may be assigned to a particular implementation 102 and may be, for example, service level agreements (SLAs).

Still referring to FIG. 1B, the implementation 102 is also indirectly related to a configuration 114, a practice 116, and an interface 118. A configuration 114 is a combination of other configurations, configuration attributes, and people that a product requires in order to provide one or more of its specified features. For example, a configuration 114 may be a configured product (e.g., a product running in an environment that best suites the product). A practice 116 is some physical set of tasks that together realizes a feature set sufficient to accomplish some activity 104 in a process. In other words, a practice 116 is a set of tasks that aids in efficient completion of an activity 104. A technical timeline 134 is also indirectly related to the practice 116, configuration 114, and interface 118. The technical timeline 134 is the state of a technical item. State, like the arrow of time, is a separate dimension that is critical when describing the future of an item. An item in the EDL 10 that has an associated timeline has a future different than what is currently known to be true. Each timeline may or may not operate on the same or similar time scale.

An interface 118 is also directly linked to a component 120. A component 120 is a piece of common technology that may be found in a technology environment. For example, a customer care system may be a component 120 of an IT enterprise. Components 120 provide their value through different physical interfaces. An interface 118 is a physical manifestation and reflects communication protocols presented by components 120. A concern 122 and a logical layer 124 also directly link to the component 120. A concern 122 is a type of general observation of something that is amiss and, if addressed, would likely increase the probability that a feature will be more compliant with specified business values. For example, a concern 122 may be that an admissions system is incredibly slow during some part of the admissions process or has a tendency to lose information when following a certain scenario. A logical layer 124 is a grouping of similarly designed or purposed applications, components, or services in a logical architecture. For example, a logical layer 124 may be a presentation layer that organizes technology specifically designed to present enterprise data on the WEB, or security layer that organizes technologies specifically designed to prevent inappropriate access to sensitive electronic data.

The interface 118 also directly relates to an attribute source 126 and a message 128. An attribute source 126 is some attribute source that is supported by the interface 118 on a component 120. For example, an attribute source 126 may be a database that stores a patients admissions data for the main hospital and all satellite clinics. A message 128 shows some communication between interfaces 118 on components 120. The message 128 effectively turns into the foundation for interface specifications. For example, a message 128 may be a request for information from the patients admissions and management system to the database storing patients admission information. The transport for this message could be in other applications or through direct means such as remote procedure calls or file transfer protocols. The message 128 is also indirectly related to a business entity 130 and a standard 132. A business entity 130 is a logical grouping of data that tends to move together between systems or used in process activities. For example, a business entity 130 may be a customer profile that contains information such as home address, telephone number, Social Security number etc. A standard 132 is some industry or commercial standard with which some item complies. For example, a standard 132 may be a common industry format such as HL7 (for health insurance and health provider organizations) or ACORD (for property-casualty insurance).

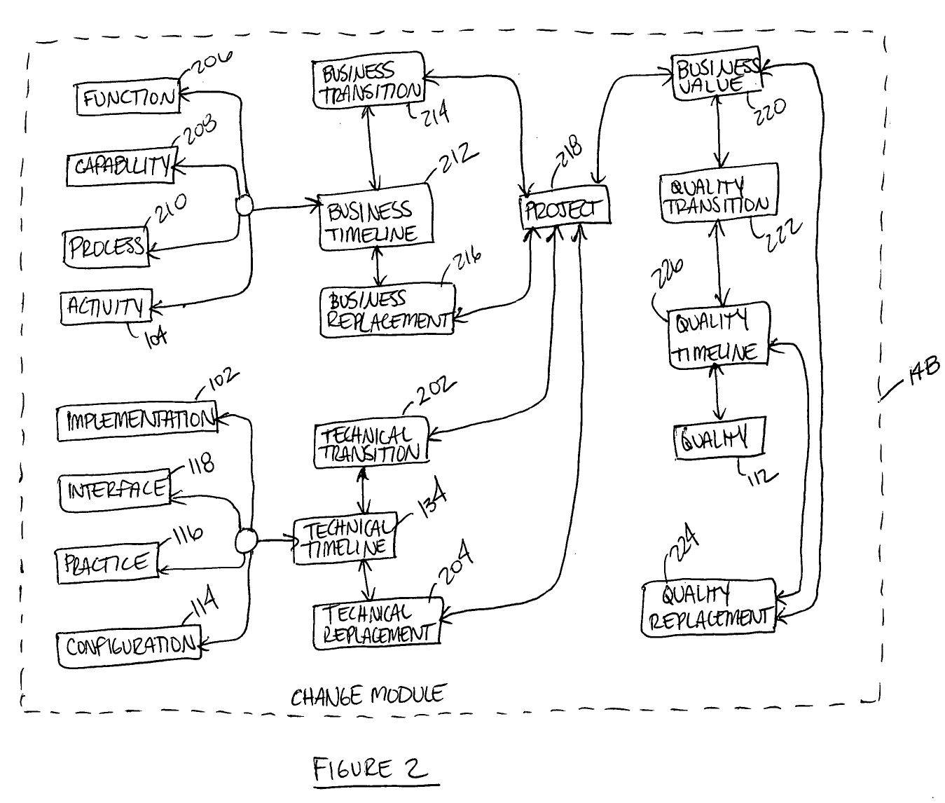

Referring now to FIG. 2, a change module 14B, according to an aspect of the present invention, is illustrated. The change module 14B is a visualization of the EDL that attempts to categorize the concepts that lay at the heart of a change within an organization. As mentioned above, various items of the modules 14 may be repeated in other modules 14. For example, the change module 14B includes the implementation 102, interface 118, practice 116, configuration 114, and technical timeline 134 as set forth in the solution module 14A. These items are all indirectly related to each other as described in FIG. 1. The technical timeline 134, as shown in FIG. 2, is also directly related to a technical transition 202 and a technical replacement 204. The technical transition 202 is a description of the change to the current state of a technical item. The change is from the current state to some future state. For example, a technical transition 202 may be a modification to an interface on a system. The technical replacement 204 describes the replacement of an existing technical item. For example, a technical replacement 204 may be a replacement of an existing system within a system or set of systems.

Remaining with FIG. 2, a function 206, capability 208, process 210, activity 104, and business timeline 212 are all indirectly related to one another. The function 206 may be either a business function (a revenue generating product or service that businesses typically advertise as the “thing they do”) or a support function that provides support to the business function. For example, the business function may be a new product sale or outpatient, surgery. Functions 206 may have a direct line of sight to revenue, whereas a support function might be human resources. A capability 208 relates either to a business capability or a support capability and is a competency area within the business and technical environment. For example, a capability 208 may be an outpatient pharmacy within a hospital, or claims processing within a health insurance company. A process 210 may be either a business process or a support process and is an end-to-end set of activities that together create value for a customer. For example, a process 210 may be an admission within a hospital, or claims adjudication within a property-casualty insurance company. The business timeline 212 is the state of a business item. For example, a business timeline 212 may represent a time span that covers an introduction of a business process all the way to the point at which that same business process is removed. For example, the business timeline 212 may be a new business process that deals with a new line of business or a new product. The business timeline 212 is directly related to a business transition 214 and a business replacement 216. A business transition 214 is a description of the change to the current state of a business item. The change relates to a change from a current state of the business item to a future state. For example, a business transition 214 may be an actual introduction of a new business process to replace an existing business process in order to more effectively and efficiently deal with a new product line. A business replacement 216 is a replacement of an existing business item. For example, a business replacement 216 may be a removal of an existing business process deemed redundant with a business process that currently exists within a recently acquired organization.

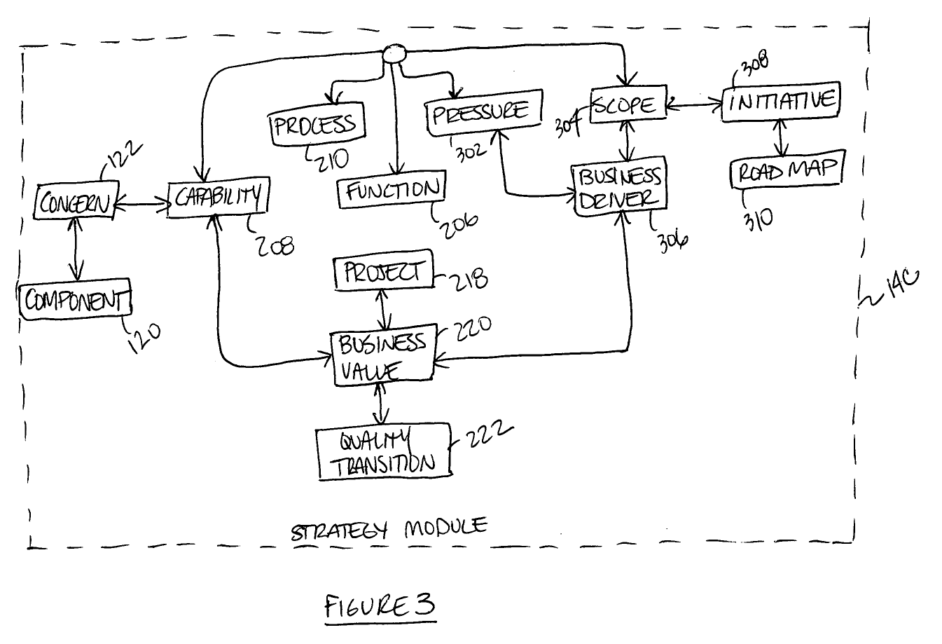

The business transition 214, business replacement 216, technical transition 202, and technical replacement 204 are directly related to a project 218. A project 218 brings change to the business and technical environment. Projects 218 change things in the IT environment with the intention of bringing value to business operations. Projects 218 require money, time, and resources, while bringing risks as described in a change management module described in FIG. 4 below. For example, a project 218 may be a series of technology replacements in order to accommodate services offered in a new hospital wing. A project 218 is also directly related to a business value 220. For example, a business value 220 may be an increase in revenue in the plastic surgery market. A business value 220 is a well-defined statement of direction, written in terms of a business model, intended to deliver on a business driver, as described in the strategy module of FIG. 3. The business value 220 is directly related to a quality transition 222 and a quality replacement 224. A quality transition 222 is a description of the change from a current state quality to a future state quality. For example, a quality transition 222 may be a shift from a maximum patient volume of 500 patients per month to 700 patients per month. A quality replacement 224 is a replacement of an existing quality. For example, a quality replacement 224 may be a new way of measuring customer satisfaction such as measuring call abandonment rates versus measuring results from customer care representative surveys. The quality transition 222 and quality replacement 224 are also directly related to a quality timeline 226 which is directly related to a quality as described in FIG. 1. A quality timeline 226 is the state of a quality 112. As set forth above, the quality timeline 226 may be similar to or different than the business timeline 212 and/or the technical timeline 134.

Referring now to FIG. 3, a strategy module 14C according to an aspect of the present invention is illustrated. The strategy module 14C is a visualization of the EDL that defines the direction that an organization intends to take to increase overall viability. Various items and their relationships from FIGS. 1 and 2 are repeated in FIG. 3. In addition, a capability 208, process 210, function 206, pressure 302, and a scope 304 are all indirectly linked to one another. Pressures 302 are forces external to the business and technical environment that lead to the creation of particular business drivers 306. For example, a pressure 302 may be a stated business objective from a competitor to increase market share in a market where the company holds a majority stake. Scope 304 represents the combination of the stated business vision provided by leaders (e.g., CEO, CIO, etc.) and the initial response by those individuals with control over pieces of the business and technical environment which can change in order to come in line with the business vision. For example, a scope 304 may be improvements to claims processing. A business driver 306, which is directly related to a pressure 302, scope 304, and business value 220, is some business objective towards which the business is working, often in response to some external pressure 302. Business drivers 306 are typically not targeted at a specific part of the business and technical environment, but are course grained and cut across the business and technical environment. For example, a business driver 306 may be to increase customer retention by 15%.

The scope 304 is also directly related to an initiative 308. An initiative 308 is used to segment business operations into focused areas for the purpose of defining those areas that are targets for improvement. For example, an initiative 308 may be something like “Bend the Trend” where a CEO of a health insurance company wants to reduce claim costs by 2% over the next two years. The initiative 308 is directly related to a road map 310. A road map 310 documents a multi-year effort to bring changes to major business and technical environment initiatives 308. The road map 310 helps group steps into group projects so that the succession of projects 218 can show how each contributes to the greater initiative 308. More than one project 218 may be required to completely realize a business value 220. By group steps, the road map 310 also correlates projects 218 so that overall costs can effectively be compared to overall value, as described more specifically with reference to FIG. 4.

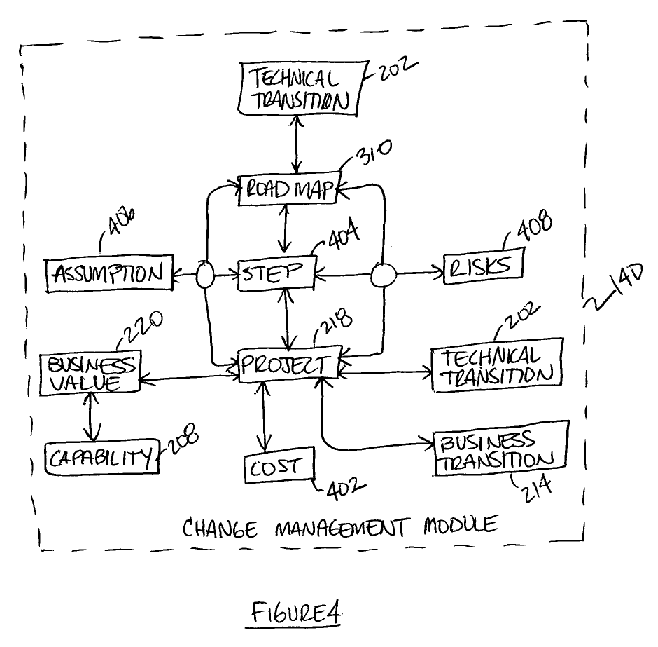

Referring now to FIG. 4, a change management module 14D according to an aspect of the present invention is illustrated. The change management module 14D is a visualization of the EDL that attempts to describe the changes that must take place to close the difference between a current direction and a desired direction of an organization. Portions of the modules 14 as described in FIGS. 2 and 3 are also repeated in the change management module 14D. In this module 14D, the technical transition 202 is directly related to the road map 310. As set forth above, the road map 310 correlates projects 218 in order to compare overall costs 402. A project 218 is therefore directly linked to a cost 402. Costs 402 are the amount of revenue consumed by an item during a period with a specified frequency, which will be described in greater detail in FIG. 5. The road map 310 and the project 218 are also directly related to a step 404. A step 404 provides a temporal grouping of projects for a particular road map 310 into these windows. In this way, a project portfolio can be generated by viewing all projects 218 within a step 404 for all road maps 310 for a given fiscal planning window. For example, a step 404 may be a business process reengineering effort, followed by a technology refreshment effort. The road map 310, step 404, and project 218 are also indirectly related to both assumptions 406 and risks 408. Assumptions 406 are judgments or beliefs about a project, a customer, or business factors that are key to decisions about project scope, requirements, deliverables, cost, schedule, resources, management, and execution. For example, an assumption 406 may be an expected purchase of an organization with complementary technology. A risk 408 is an exposure to an event or set of circumstances that may cause loss or damage. It is the recognition of future uncertainty. Uncertainty is that which cannot be depended upon (that which is subject to change). An uncertainty can be viewed in a positive or a negative way. For example, a risk 408 may be the price of oil as it might impact stock prices of energy organizations looking to refresh some other technologies.

The project 218 is also directly linked to a technical transition 202, business transition 214 and business value 220 as previously shown and described in FIG. 3. A business value 220 is directly related to a capability 208 as also previously described with reference to FIG. 3.

Referring now to FIG. 5, a finance module 14E according to an aspect of the present invention is illustrated. The finance module 14E describes a visualization of the EDL that encompasses both revenue gained and money consumed by conducting business. FIG. 5 describes various links between items of FIG. 1 and FIG. 2 as well as other items not previously described. A cost 402, business transition 214, technical transition 202, project 218, actor 108, configuration 114, and support process 210B are all indirectly linked to one another. A support process 210B is similar to a business process (as described below) except that there is no direct line of site to revenue. Instead, a support process 210B provides value to actors 108 in support of business processes 210A. For example, a support process 210B may be boarding new employees that might be expensive and a redesign, but does not have a direct impact on revenue being generated.

Costs 402 are also directly linked to a chart of accounts 502. A chart of accounts 502 is the account against which monetary items are logged. Therefore, the chart of accounts 502 is also directly linked with revenue 504. Revenue 504 represents some monetary value either lost or gained. Revenue 504 is indirectly related to a situation 110 and directly related to a business process 210A. A business process 210A is an end-to-end set of activities that together create value for a customer. For example, a business process 210A may be surgery room processes since the execution of such processes will lead directly to revenue being generated.

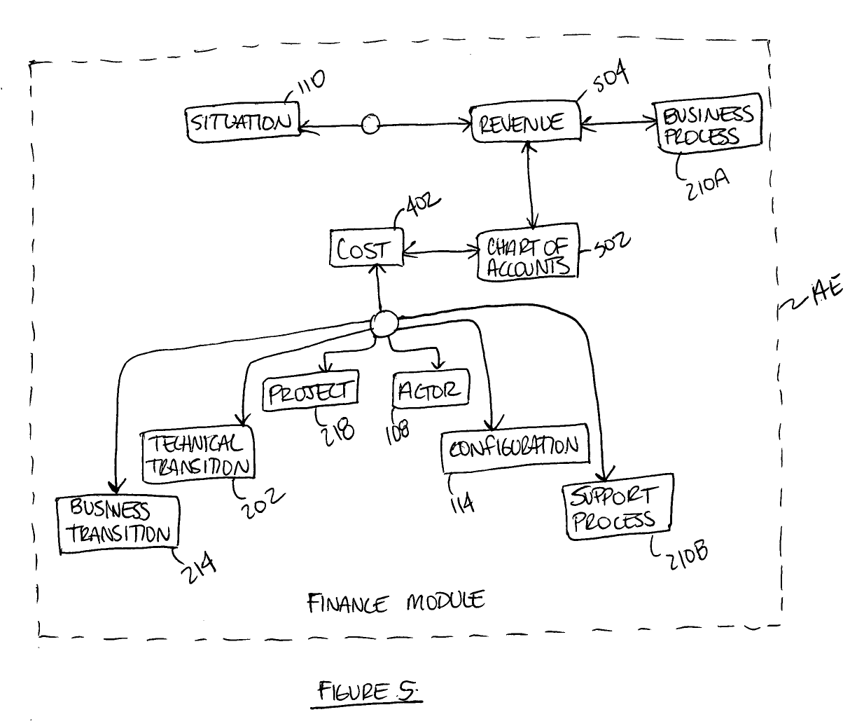

Referring now to FIG. 6, an information module 14F in accordance with an aspect of the present invention is illustrated. The information module 14F is a visualization of the EDL that represents the data an organization uses to conduct its business and the relationships that exist between various data and ultimately systems of record. A business entity 130 is indirectly related to a message 128 and an activity 104, as previously illustrated by FIG. 1. The business entity 130 is also directly related to a business entity relationship 602. A business entity relationship 602 represents a relationship between two or more business entities, of which there are three types (Associative, Aggregate, and Extends). The business entity 130 is also indirectly linked to a standard and an attribute 604. An attribute 604 is a facet of a business entity 130. For example, an attribute 604 may be an address at a customer profile, whereas the customer profile is the business entity. The attribute 604 is also directly linked to an attribute source 126 which, in turn, is directly linked to an interface 118 and indirectly linked to a situation 110 as previously described with respect to FIG. 1.

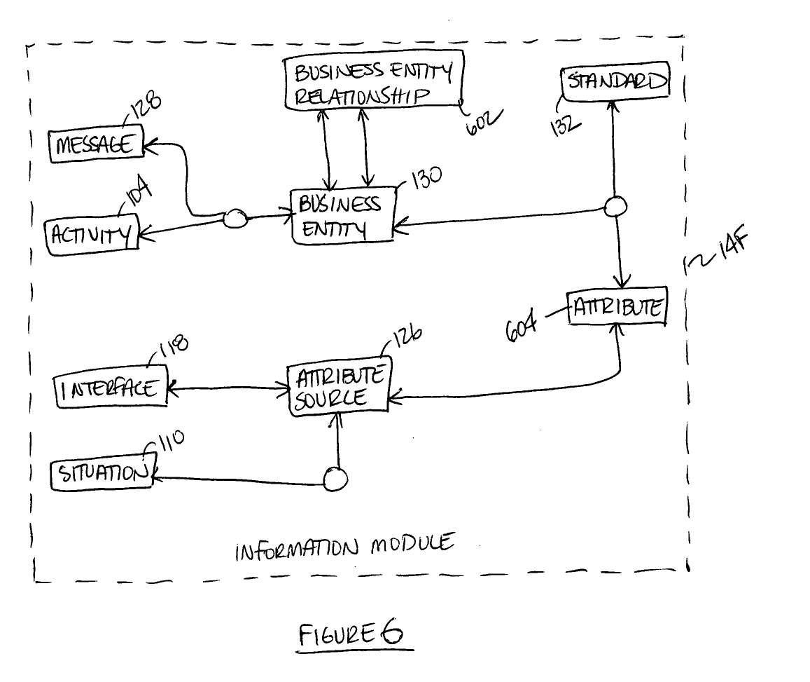

Referring now to FIG. 7, a compliance module 14G in accordance with an aspect of the present invention is illustrated. The compliance module 14G is a visualization of the EDL that serves as additional dimensions of definition that cut across many different items within the business and technical environment. Functions 206, activities 104, implementations 102, and qualities 112 are all indirectly related to both a situation 110 and a process 210. In addition, revenue 504 and an attribute sources 126 are indirectly related to a situation 110. A situation 110 is directly related to a circumstance 702. A circumstance 702 describes the facets of the situation 110. For example, a circumstance may be “platinum” versus “gold” customers. The quality 112 is also directly linked to an impact 704. An impact 704 represents the relationship that one quality 112 has on other qualities 112 in terms of positive and negative influences. The impact 704 enables planners to mitigate negative influences, or capitalize on positive influences. For example, an impact 704 may be a situation according to which increasing the volume of patients results in an increase in the number of medications dispensed.

Qualities 112 are also directly linked to a measurement 706, which is indirectly linked to a standard 132. The standard 132 is also indirectly linked to a process 210, configuration 114, message 128, business entity 130, and attribute 604. The measurement 706 is the method of measurement by which the quality is determined. For example, a measurement 706 may be the number of calls abandoned for a customer call center.

Also within the compliance module 14G is a principle 708. A principle 708 helps guide development team decisions as they aid in evaluating the pros and cons of various options. Principles 708 are much like building codes created by cities and towns that regulate choices and construction methods. Principles 708 are indirectly related to both a physical layer 710 and a logical layer 124. A physical layer 710 is a grouping of similarly constructed or purposed applications, components, or services in the business and technical environment.

Referring now to FIG. 8, a workflow module 14H in accordance with an aspect of the present invention is illustrated. The workflow module 14H is a visualization of the EDL that combines business processes and their accompanying activities that enable features and deliver on functions. Support processes 210B, business processes 210A, scope 304, standards 132, triggers 802, qualities 112, and activities 104 are all indirectly linked together. A trigger 802 signals an important occurrence that starts processes necessary to handle an event. For example, a trigger 802 may be a scheduled surgery or a submission of a purchase order for a new product.

In this module 14H, a business process 210A is also directly related to revenue generated 804, a customer 806, and a business capability 208A. A customer 806 is defined as any person or entity that subscribes to services, or uses products provided by the business in return for money or trade. For example, a customer 806 may be an employer, hospital, or members of a health insurance company, wherein all pay for services provided by the health insurance company. A support process 210B is directly linked to an actor 108, costs 402, a support capability 208B, and a transition 808. A transition 808 occurs within an activity 104 whenever some specified condition is true. For example, a transition 808 may be an opportunity for cross marketing changes from a customer care call to sales call. As such, the transition 808 is also indirectly related to an activity 104. The transition 808 is also directly linked to a condition 810. Upon the truth of a condition 810, the transition 808 may initiate other processes, or may loop back to the beginning of the current process. The business process 210A and support process 2101B are indirectly linked to the business timeline 212.

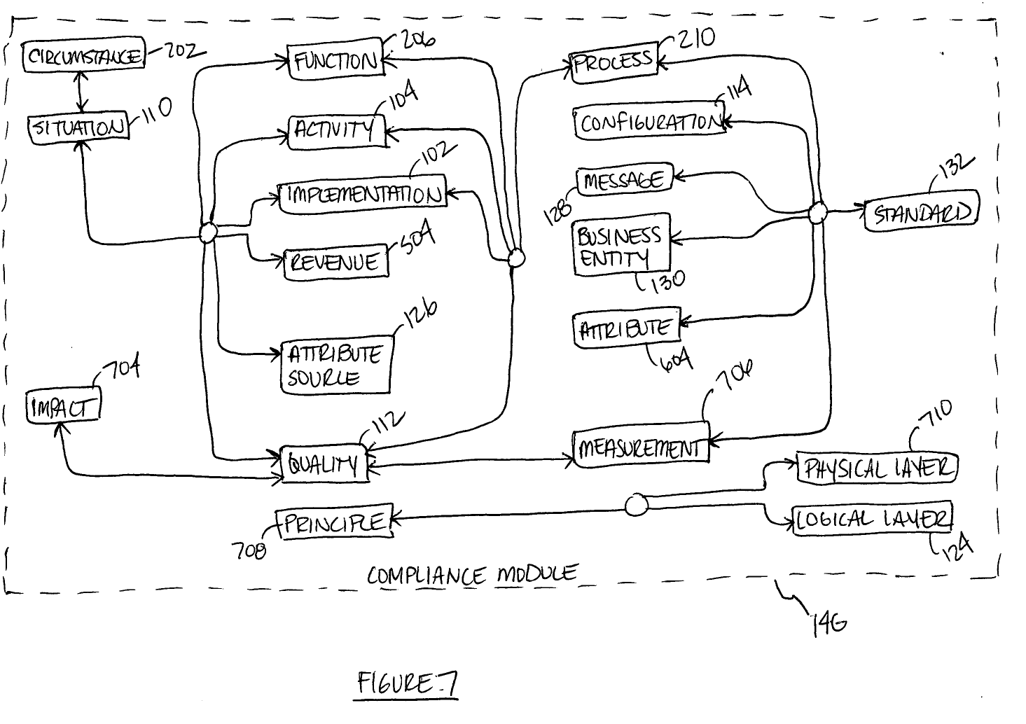

Referring now to FIG. 9 a business module 141 in accordance with an aspect of the present invention is illustrated. The business module 141 visualizes a portion of the EDL that lays out an organization's business and support functions and the capabilities of the organization that realize those functions. A quality 112 is indirectly linked to both a business function 206A and a support function 206B. A business function 206A is a revenue generating product or service that organizations utilize as a portion of their core business. Business functions have a direct line of site to revenue 504. For example, a business function 206A may be a surgery or a psychiatric service for a hospital. A support function 206B does not have a direct line of site to revenue 504, but is in support of a business function 206A. For example, a support function 206B may be human resources. The business function 206A is also directly related to a business feature 902. Business features 902 describe what the business and technical environment does and are detailed enough to be meaningful. Similarly, a support function 206B is directly linked with a support feature 904. A support feature 904 is similar to a business feature 902 except that the support feature 904 does not have a direct line of site to revenue 504. For example, a business feature 902 may be new customer sales versus existing customer sales and a support feature 904 may be a benefit administration within human resources. Scope 304 is indirectly linked with a business function 206A, a support function 206B, a business feature 902 and a support feature 904. The business timeline 212 is also indirectly linked with a business function 206A, support function 206B, business feature 902, and support feature 904.

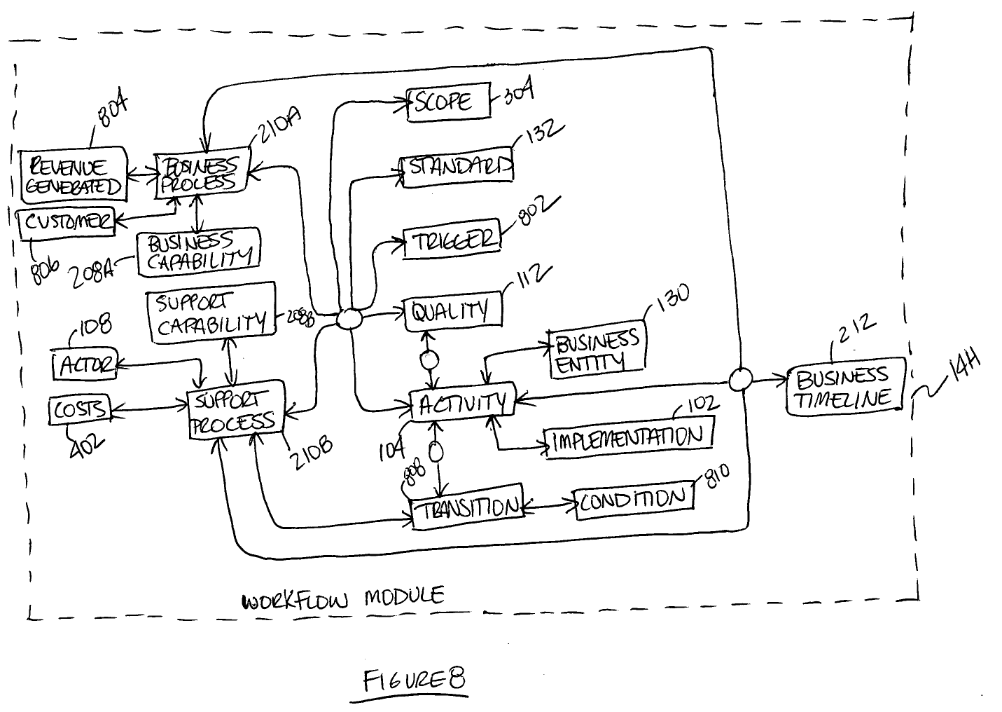

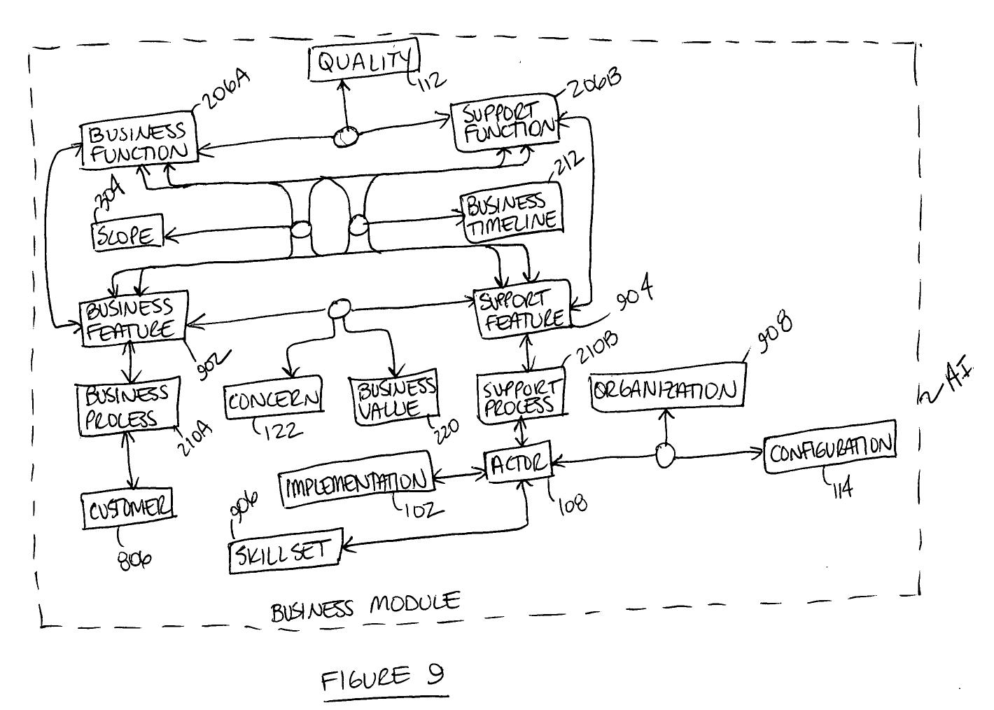

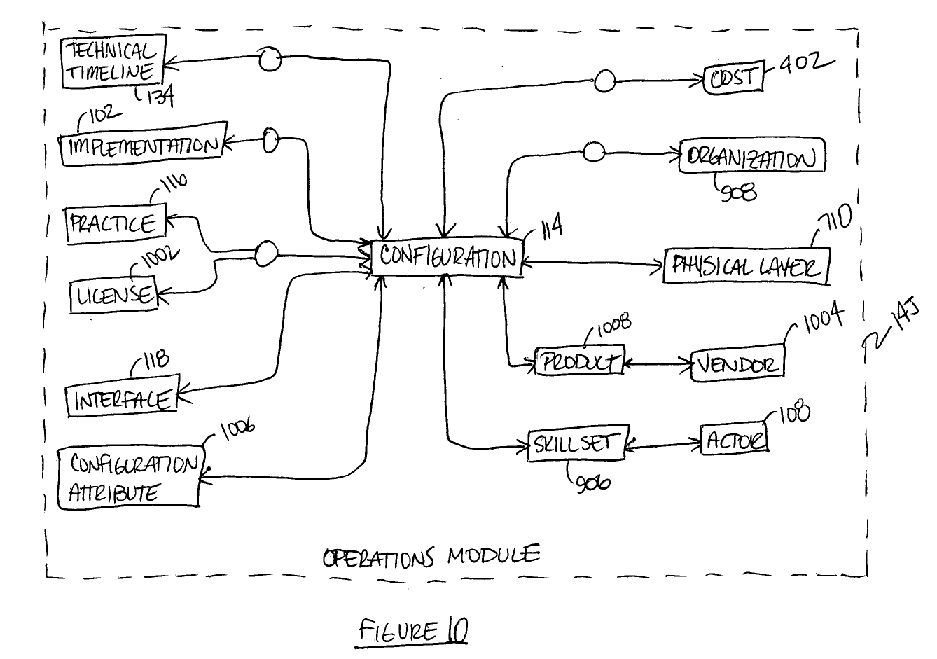

Business features 902, support features 904, concerns 122, and business values 220 are also indirectly linked. The business feature 902 is directly linked to a business process 210A which, in turn, is directly related to a customer 806. The support feature 902 is directly linked to a support process 210B which is directly linked to an actor 108. The actor 108 is directly related to an implementation 102 and a skill set 906. A skill set 906 describes the skills in terms of qualifications and responsibilities required to maximize the chances of successfully using the item required to realize some implementation 102, which will be described in further detail with reference to FIG. 10. For example, a skill set 906 may be underwriting or actuarial skills for an insurance company. The actor 108 is also indirectly linked to an organization 908 and a configuration 114. The organization 908 is some structure used to oversee a group of organizational resources such as actors 108 or configured products, also described in FIG. 10. For example, an organization 908 may be an underwriting department of a property-casualty insurance company, or a customer care center for an online retail company.

Referring now to FIG. 10, an operations module 14J in accordance with an aspect of the present invention is illustrated. The operations module 14J is a visualization of a portion of the EDL that details the set of products (hardware, software, etc.) that enable the successful delivery of business activities 104. In the operations module 14J, a configuration 114 is indirectly linked to a technical timeline 134, implementation 102, cost 402, and organization 908. In addition, the configuration 114, practice 116, and a license 1002 are all indirectly related to each other. A license 1002 describes a usage contract placed on an item by a vendor 1004. For example, a license 1002 may be the Mozilla licensing agreement often associated with open-source software.

The configuration 114 is also directly linked to an interface 118, configuration attribute 1006, skill set 906, product 1008, and physical layer 710. A configuration attribute 1006 is some requirement of a product that is necessary for the configuration for that product 1008 to work as expected. For example, a configuration attribute 1006 may be a number of processors and a large server (which often ranges from two to four). A product 1008 is a hardware or software solution that provides some value designed to enable the ultimate successful delivery of some activity 104. For example, a product 1008 may be an Epic product often used in the healthcare industry. The skill set 906 is directly linked to an actor 108 and a product is directly linked to a vendor 1004. A vendor 1004 (e.g., Microsoft, Oracle, Sun, IBM) represents an organization responsible for creating a product or providing a service.

Referring now to FIG. 11, an architecture module 14K in accordance with an aspect of the present invention is illustrated. The architecture module 14K represents a visualization of a portion of the EDL that describes logical and physical layers that support the company's business processes. In this view, a component 120 is directly linked with a logical layer 124 which, in turn, is directly linked with a physical layer 710 and a logical architecture 1102. A logical architecture 1102 delivers the design in such a way that it models what actually is required without taking real life constraints into consideration (i.e., an ideal world scenario).

The physical layer 710 is also directly related to a configuration 114 and a physical architecture 1104. A physical architecture 1104 addresses the “with what” aspects of the architectural design. It translates the logical design into buyable products and solutions that can be implemented. For example, a physical architecture 1104 may be a business lines architecture that contains all applications for business lines administration and management for property-casualty insurance company. The physical design reflects what can be achieved at a certain point. Both the physical architecture 1104, the logical architecture 1102, and a dynamic view 1106 are indirectly related. The dynamic view 1106 is a description of architectural elements in action. For example, a dynamic view 1106 may be messages that pass between all of the business lines application.

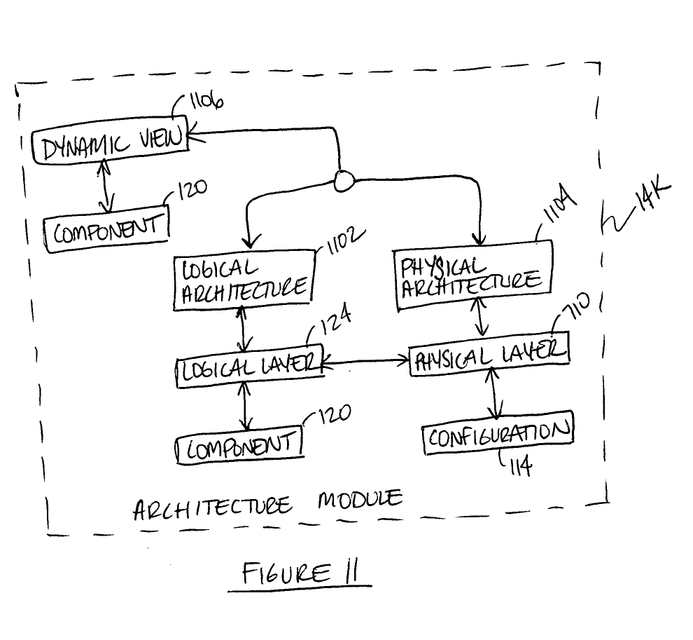

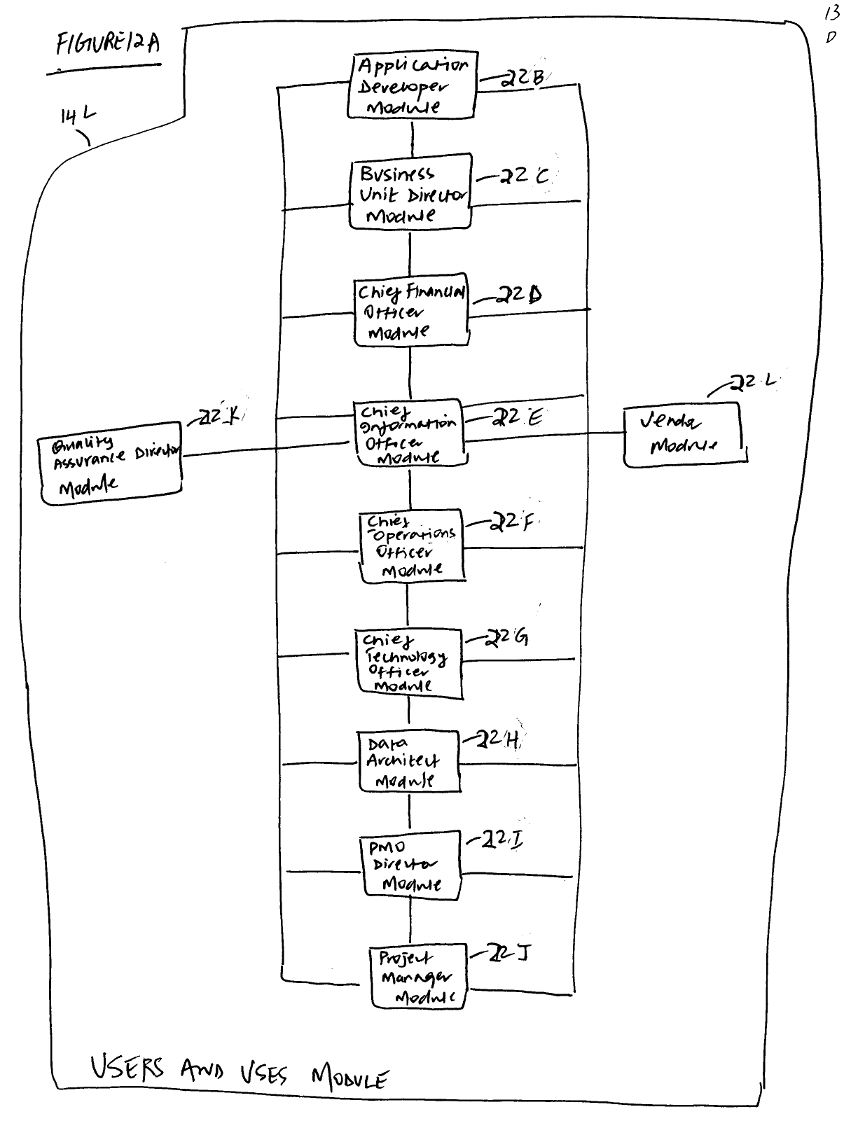

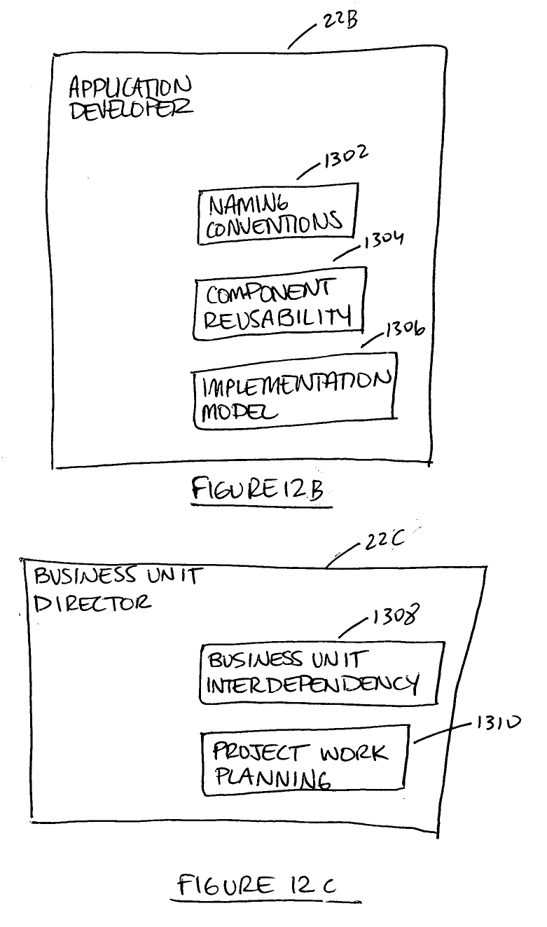

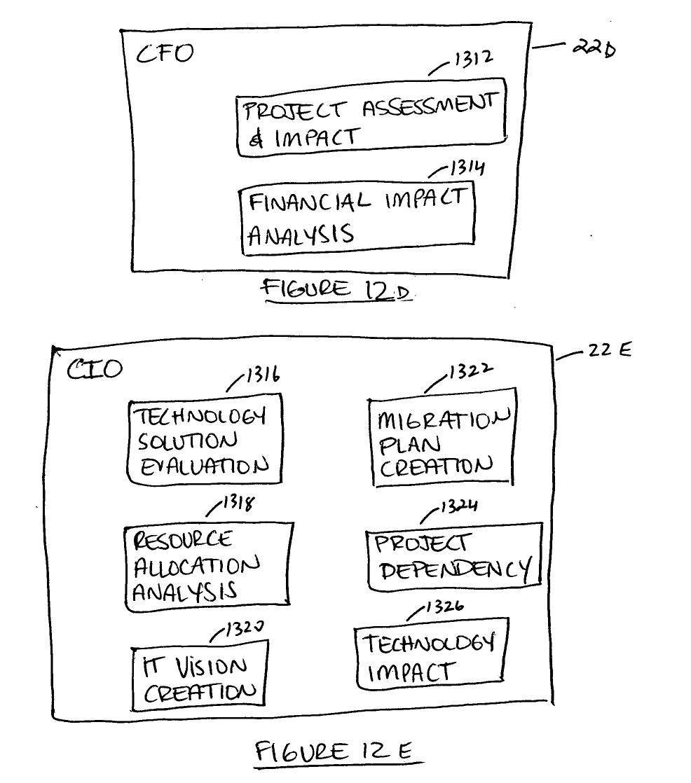

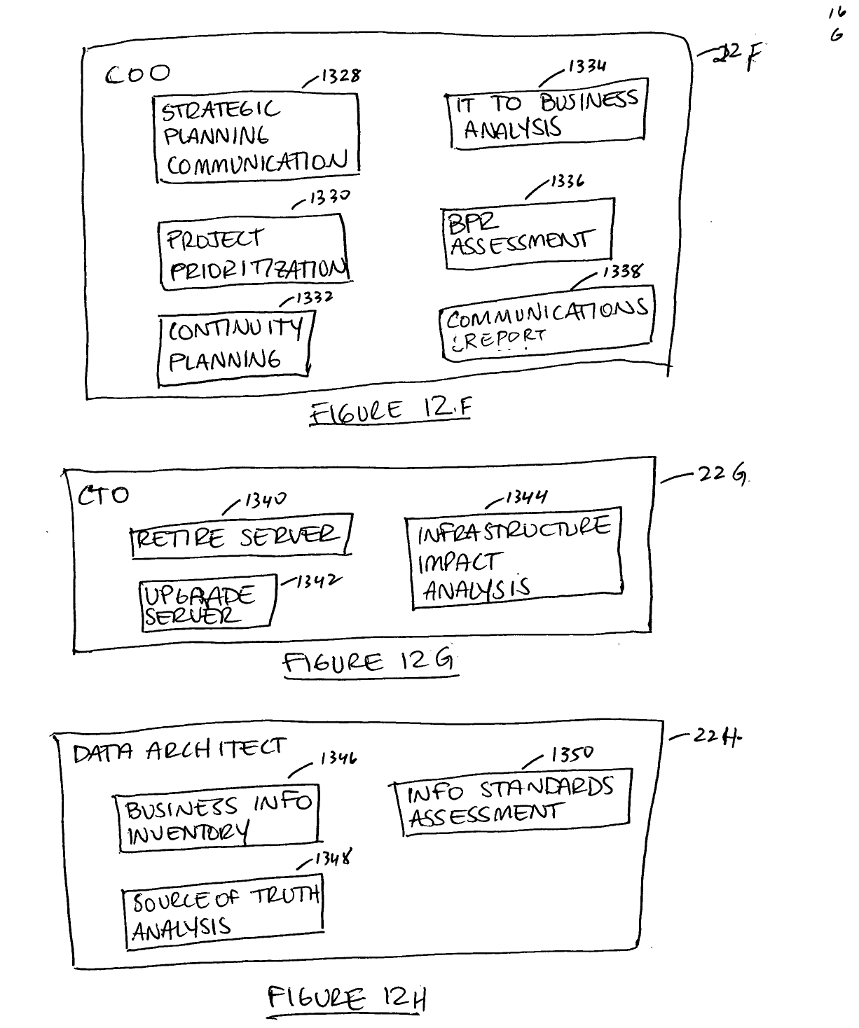

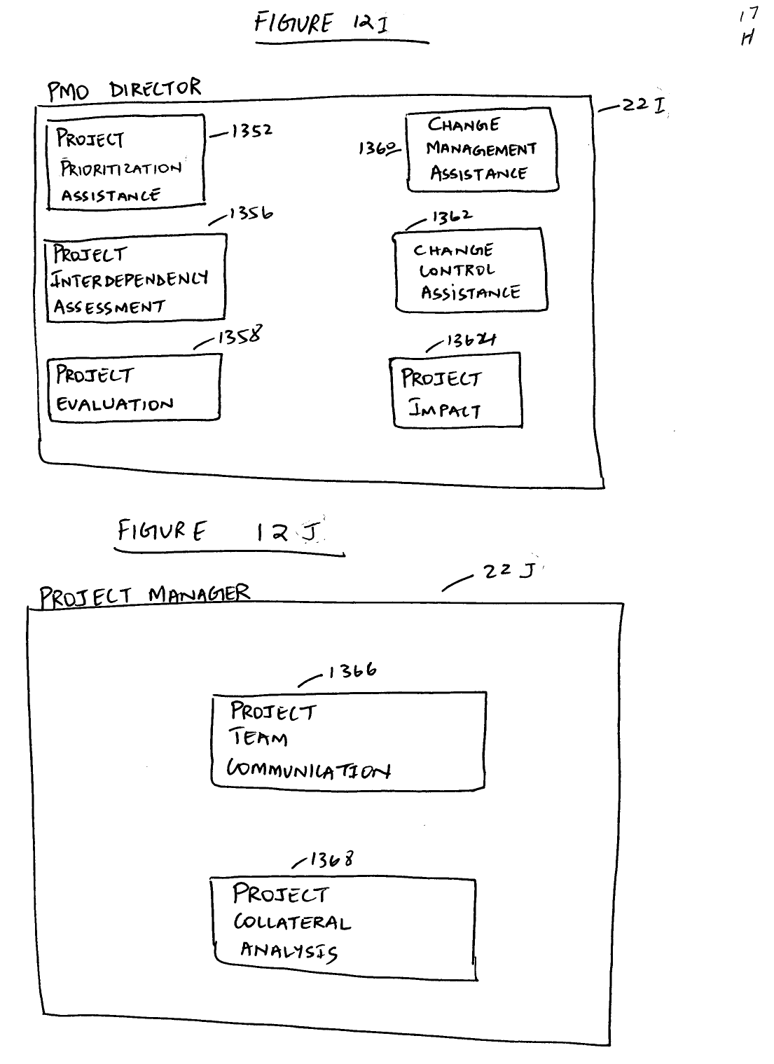

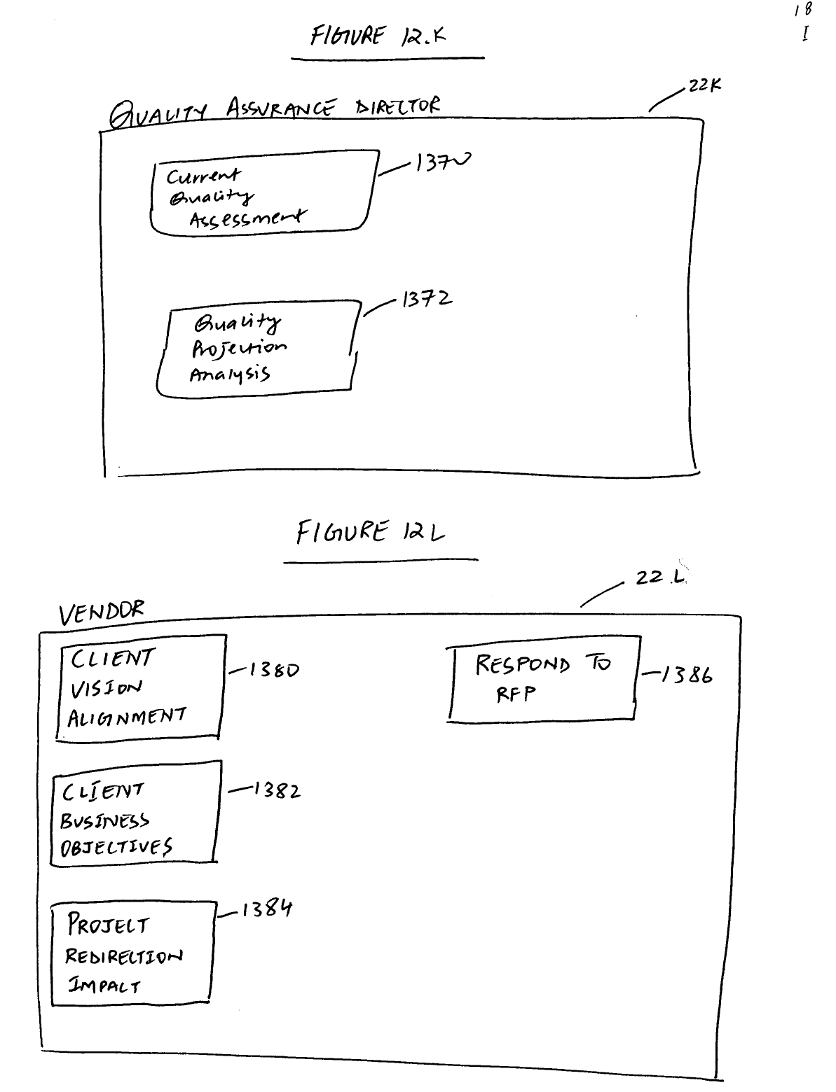

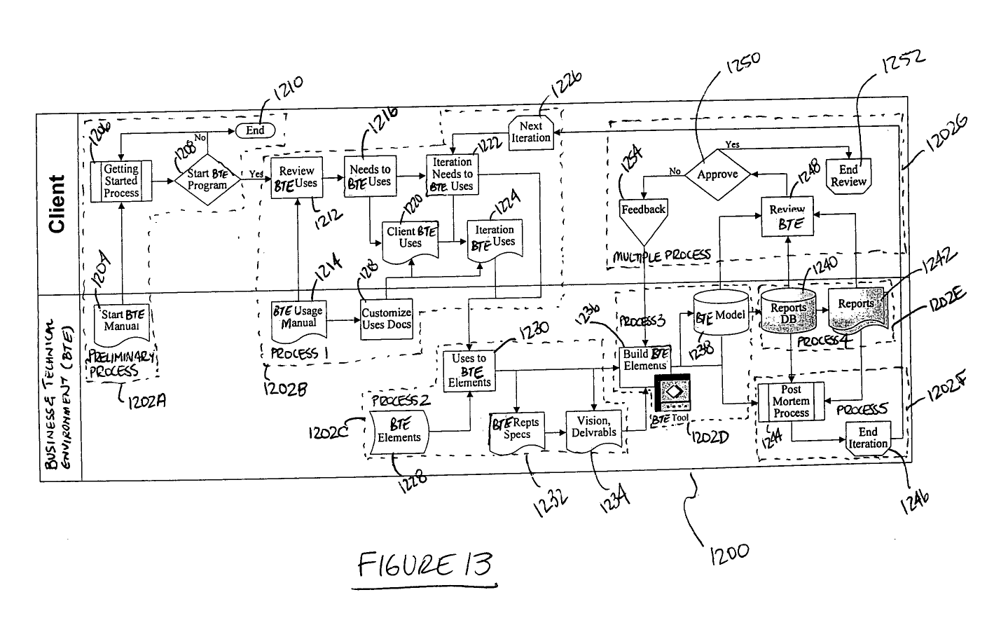

Referring now to FIG. 12A, a block diagram of the users and uses module 14L is illustrated. The users and uses module 14L aids in the identification of business problems with respect to initial outsourcing and maintenance of the outsourcing relationship. In this module 14L the business problems are identified, described, and categorized. For instance, the business problems may be categorized according to a type of user. In addition, the concepts within the different modules 14 that may be required to solve business problems have been identified. For example, when bringing down servers for maintenance, not all portions of the EDL 10 may be affected. The portions of the EDL 10 that are affected by the particular business problem are then related to that business problem. The various portions of the users and uses module 14L are visually illustrated with reference to the modules as described below in FIGS. 12B-12L.

Referring now to FIG. 12B, an application developer module 22B of the users and uses module 14L according to an aspect of the present invention is illustrated. The application developer module 22B is a visualization of the users and uses module 14L that is responsible for realizing the features needed by a business. The application developer module 22B includes naming conventions 1302. The naming conventions 1302 provide a compilation of project information that identifies consistent terminology. The application developer module 22B further includes component reusability 1304 and implementation model 1306. The component reusability documents all IT assets (implemented, proposed and under development) the ability to identify reusable components. The implementation model 1306 provides a list of all the elements that are involved in realizing the solution to a desired change. The implementation model 1306 creates a relationships between the features needed and software components (products, interfaces, transactions, data sources, etc.) that are integral for the implementation of those features. The implementation model 1306 also maps the features to the organizations and users for whom they are being developed.

Referring now to FIG. 12C, a business unit director module 22C of the users and uses module 14L according to an aspect of the present invention is illustrated. The business unit director module 22C is a visualization of the users and uses module 14L that is responsible for the effectiveness and efficiency of a business unit. Each business unit functions as a contributor to a coordinated enterprise by which revenue is generated and performs business processes that are dependent on the objectives and functions of another business unit. The business unit director module 22C includes a business unit interdependency report 1308 that correlates important issues between each business unit. The business unit director module 22C further includes a project work plan 1310 that provides step-by-step instructions for constructing project deliverables. The project work plan 1310 also aids in managing project implementation. The project work plan 1310 typically includes quality management, risk management, issue management, scope management and communications management.

Referring now to FIG. 12D, a chief financial officer module 22D of the users and uses module 14L according to an aspect of the present invention is illustrated. The chief financial officer module 22D is a visualization of the users and uses module 14L that is responsible for the financial success of an organization. The chief financial officer 22D is responsible for the financial management activities of the programs and operations of the organization. The conceptual phase of the project management methodology recommends performing a project assessment and impact study 1312 to analyze the benefits, opportunities, risks, and cost estimates of a project. The project information collected (e.g., business drivers, qualities, desired changes, impacted business functions, processes, information and customers solutions, required technology etc.) provides a platform to assess the project feasibility and identifies recommended solutions. Projects that efficiently target critical business drivers and maximize positive impact on qualities at minimal risk and liability are visualized in the project assessment and impact report 1312. Financial impact analysis report 1314 helps in estimating project costs. In addition, the financial impact analysis report 1314 also serves as a general avenue for developing and communicating the financial analysis to shareholders.

Referring now to FIG. 12E, a chief information officer module 22E of the users and uses module 14L according to an aspect of the present invention is illustrated. The chief information officer module 22E is a visualization of the users and uses module 14L that is responsible for the vision, strategy, direction, guidelines, policies, planning, coordination, and oversight of the organization. The chief information officer module 22E is further responsible to set strategies for technology use at the organization and to define the organization's problem with respect to technology solutions. The chief information officer module 22E includes a technology solution evaluation report 1316 that documents an impact of a desired change and corresponding solution on the organization. The chief information officer 22E is responsible for positioning limited resources. To better allocate those resources, projects often need to be prioritized as to their critical impact on the business objectives, the operational procedures and processes, customers, cost, etc. The resource allocation analysis report 1320 provides information to the chief information officer 22E regarding the technologies and feature sets that are currently in place from which reuse is possible. The IT vision report 1320 includes the activities and objectives of IT as they relate to a business model.

Whenever a project involves migration from one system in the to another, the formulation of a thorough migration strategy is critical in terms of accomplishing the migration with minimal negative impact on the customer and thus the business revenue. A successful migration must identify all business information and the supporting components touched by the migration. The migration plan report 1322 tracks all the relationships between technology to be migrated and the business drivers, processes, customers, data, interfaces, etc. Project Dependency report 1324 includes enterprise components and their relationships to each other. When planning a technology change (e.g., retiring an application, deploying a new application, changing vendors etc.) the impact of such a change must be identified and procedures put in place to minimize or eliminate the risk. The technology impact report 1326 maps all technologies to their interfaces, business processes, business entities, message threads, and business drivers.

Referring now to FIG. 12F, a chief operations officer module 22F of the users and uses module 14L according to an aspect of the present invention is illustrated. The chief operations officer module 22F is a visualization of the users and uses module 14L that is responsible for the overall effectiveness and efficiency of the processes required to support a business process. The chief operations officer module 22F includes a strategic planning communication report 1328. Strategic planning involves knowing where the organization is at present and where the organization wants to be in the future. Strategic planning focuses on what the organization wants to do on behalf of the customer and the operational processes required to achieve those future goals. Strategic planning communication report 1328 maps the current relationships between the business objectives and IT and documents the desired future state. Part of the task of realizing the strategic plan is to evaluate projects, their impact on, and contribution to the strategic plan. Project prioritization report 1330 provides critical information relating to projects that will bring about the most significant enhancements to the organizations standards and requirements. The continuity planning report 1332 tracks the relationships between the business processes and the computer systems and data. The continuity planning report 1332 further connects the business model to the IT model. In general, the continuity planning report 1332 provides valuable information for developing a business continuity plan. The business mapping report 1334 maps the business drivers and qualities to their corresponding business functions and related processes.

Improving the quality of business processes is one of the chief operations officers 22F primary interest. Processes that best serve the values and objectives of the organization and provide the greatest and most efficient service to the customer are vital. The business process improvement report 1336 correlates the organizations standards with the desired changes and the recommended solutions. The chief operations officer 22F communicates the business model to IT. On the other hand, IT communicates the IT model to the Chief Operations Officer 22F. The chief operations officer/IT communications report merges both the business model and the IT into a consolidated, objective report that displays the relationships between the two. The communications report 1338 serves to eliminate cognitive dissonance.

Referring now to FIG. 12G, a chief technology officer module 22G of the users and uses module 14L according to an aspect of the present invention is illustrated. The chief technology officer module 22G is a visualization of the users and uses module 14L that is responsible for the vision, strategy, direction, guidelines, policies, planning, coordination, and oversight of the organization's technical infrastructure. The chief technology officer module 22G determines strategies for infrastructure use at the organization and defines the organizations business problems in terms of infrastructure solutions. In order to reduce costs, poorly utilized servers are often put on a rapid retirement schedule 1340. In order to do this, the organization must understand all of the configuration and application ramifications. In order to successfully decommission servers, it is critical to understand all of the applications that run on that server and the configurations those applications need in order to work as expected. Furthermore, it is critical to understand what business processes those applications support in order to determine any financial impact of taking those servers down.

Referring now to FIG. 12H, a data architect module 22H of the users and uses module 14L according to an aspect of the present invention is illustrated. The data architect module 22H is a visualization of the users and uses module 14L that is responsible for the integrity and integration of critical information related to a business to support the business. The data architect module 22H includes a business information report 1346. The business information report 1346 documents the relationships that exist between a given composite of business data and the components of the enterprise (both business components and IT components). The business information report 1346 enables the data architect 22H to understand how the business uses the information, thus facilitating the management of the data to best support the business. A data source mapping report 1348 documents and traces all the components of business information. The data source mapping report 1348 includes the source of the data, the attributes of the data, the business entities that are a compilation of the data, the inter-data relationships, the interfaces that interact with the data source, and the business processes that use the data. An information standards assessment report 1350 documents all data and its relationships to the enterprise. The information standards assessment report 1350 enables a single attribute of information (e.g., patient name) to be consistently referenced by all business entities that use that attribute (e.g., patient record, patient contract etc.).

Referring now to FIG. 12I, a project manager officer (PMO) director module 22I of the users and uses module 14L according to an aspect of the present invention is illustrated. The PMO director module 22I is a visualization of the users and uses module 14L that is responsible for maximizing the effectiveness and efficiency of the tactical and strategic project spending by identifying and managing enterprise-wide touch-points shared between projects. The PMO director 22I further supports the organization and project managers by providing a consistent approach for defining, initiating, controlling and closing down projects for which the business and technical environment serves as the primary source of knowledge. The PMO director module 22I includes a project priority assistance report 1352 that provides a list of projects based on their priority. It is critical that inter-project dependencies be identified and coordinated to increase the overall efficiency and effectiveness of the execution of all projects. The inter-project dependency report 1356 documents the enterprise wide touch-points between projects. The progress and benefit of all projects are evaluated at each phase. The project evaluation report 1358 provides a mechanism whereby the project management office can monitor projects at each phase to ensure that they are successfully following the standards and requirements and producing deliverables that are aligned with business drivers. The project evaluation report 1358 traces each project to the business drivers being addressed and the qualities being enhanced to facilitate value evaluation. The project evaluation report 1358 facilitates the task of setting and validating the achievement of success criteria. The change management assistance report 1360 documents and tracks all projects in the critical areas of change management. The change management assistance report 1360 serves as an integral tool in formulating a change management strategy. The project management office is responsible for monitoring the scope of a project. Once the baseline project plan is approved, any changes to the scope requires management approval. These requested changes must be measured against the baseline to determine the impact to cost, schedule and deliverables. The change control assistance report 1362 maps baseline changes to the enterprise components impacted by those changes. For example, it may be that two projects propose enhancing two, seemingly different projects. However, upon closer examination of the EDL specification for the projects, it is discovered that the applications share a common business entity, thereby increasing the potential that the projects may clash.

Referring now to FIG. 12J, a project manager module 22J of the users and uses module 14L according to an aspect of the present invention is illustrated. The project manager 22J is a visualization of the users and uses module 14L that is responsible for the successful implementation of projects. The project manager module 22J includes a development team communication report 1366 that documents the features requiring development for accomplishing the desired changes which satisfy the business objectives of the organization. As an example, the development team communication report 1366 may include information regarding the software components needed to support the features, the transactions that must occur between these components and the interfaces that connect them. For example, a project team may need to coordinate with another team currently in the process of updating an interface on a component that is part of the overall project plan.

Referring now to FIG. 12K, a quality assurance director module 22K of the users and uses module 14L according to an aspect of the present invention is illustrated. The quality assurance director module 22K is a visualization of the users and uses module 14L that is responsible for identifying and realizing opportunities for service level agreement enhancements. All businesses are built around the service level agreements and other standards according to which organizations must comply in order to be competitive and financially viable. The objective of every project is to enhance performance and service to better meet or exceed one or more of these standards (qualities). The quality assurance director module 22K includes a current quality assessment report 1370 that links qualities with its business drivers to establish a correlation between the objectives of the organization and the objectives which have been successfully achieved. The quality assessment report 1370 includes a method of measurement by which each quality is deemed accomplished. The quality assessment report 1370 further provides the framework for documenting the current qualities. The quality assurance director module 22K further includes a quality projection analysis report 1372 that documents relationships between service level agreements and individual processes and procedures that accomplish each business goal.

Referring now to FIG. 12L, a vendor module 22L of the users and uses module 14L according to an aspect of the present invention is illustrated. The vendor module 22L is a visualization of the users and uses module 14L that is responsible for proposing and providing well defined solutions to business problems. In order for a vendor to be able to offer a product that efficiently and effectively solves a business problem or provides a solution to some desired change, the problem and desired change must be understood in real world terms. The vendor module 22L includes a client vision alignment report 1380 that is a source by which the vendor understands the organizations vision. The client vision alignment report 1380 further provides the vendor 22L with important information for formulating a proposal. However, if the vendor 22L is unaware of the organization's business objectives, the vendor 22L is hard pressed to be innovative in order to manipulate the products and services to best improve the business. A client business objective report 1382 defines the operations of the organization along with the technology supporting the organization. A project redirection impact report 1383 provides information regarding a business process and the impact that it may have on other entities (regulatory constraints, budgetary constraints, economic conditions, competitor issues etc.). A request for proposal report (RFP) 1386 is a primary tool by which the business initiates correspondence with vendors. The creator of the RFP report 1386 may need any combination of details for soliciting a response from vendors. Depending on the kind of solution targeted by the RFP report 1386 (e.g., creative alternatives, solutions specific to a set of requirements, etc.), the RFP report 1386 provides the information (HW/SW requirements, network topology, financial data, Service Level Agreement parameters, license data, standards and desired changes, etc.).

Referring now to FIG. 13, a flow diagram 1200 for implementing embodiments of the present invention is illustrated. The flow diagram 1200 illustrates the steps necessary to complete a single implementation iteration, however several iterations may be necessary to complete the entire process, depending on the complexity of a need structure. For example, each iteration may accommodate a set of needs based on need priorities, need urgencies, need anticipation, etc.

The flow diagram 1200 has been divided into process areas 1202 that will be described in detail below. The preliminary process area 1202A first involves identifying ways in which the client will leverage the information model described using the EDL. These uses can come from a pre-existing catalog of previously identified needs often found in a particular industry or can be constructed from scratch. These value propositions, or uses, are then mapped to the various concepts within the EDL such that a user immediately understands what concepts are germane to their particular needs. The enables an author of the outsourcing specification to immediately know what sort of information to collect. The flow diagram 1200 then proceeds to process area 1 1202B. Process area 1 1202B allows correlation of client needs to a business and technical environment. Process area 1 1202B controls the building of the business and technical environment to be value-centric and provides boundaries and guidelines for building an organization that includes enabling information (e.g., information that provides a benefit). Process area 1 1202B also organizes the building of the business and technical environment into need and value-centric iterations that move from the more critical to the less critical, but equally important, uses. This bottom-up approach driven from specified client needs ensures that only relevant information is collected at any given time. Over time, this targeted collection of local information can lead to global wisdom about the enterprise.

At step 1212, the business and technical environment uses are reviewed. The business and technical environment uses are value outputs of an integrated business and technical environment. As the elements of each organization segment are defined, interrelated, and built, the information and relationships become useful for accomplishing various tasks, such as IT planning decisions, investment decisions, guiding development efforts, etc. At step 1216, client needs are correlated to the business and technical environment uses. The client needs may be of a more critical nature because of a specific and/or urgent problem that must be resolved in a timely fashion. For example, business process standardization efforts may be expedited with maximum benefit to the stakeholders.

Step 1218 recognizes that the initial catalog of uses developed prior to any experience with a particular client environment might not be specialized sufficiently to accommodate the unique traits of the client and as such might require specification of these unique uses. At step 1226, a determination is made as to whether another iteration should be enacted. The basis for this determination is made at step 1246 of process area 5 1202F, which will be described in further detail below. If another iteration is to be made, then the process repeats at step 1222.

The flow diagram 1200 then proceeds to process area 2 1202C. Depending on the client needs and corresponding uses selected to mitigate those needs, organization segments and related elements are designed and built accordingly for that iteration. At step 1228, the business and technical environment elements are correlated to the corresponding uses. At step 1230, the elements from step 1228 are correlated with the information from process area 1 1202B to allow the specific iterations to be designed and built. At step 1232, reported specifications are used to bring together the elements from the EDL and report form that provides useful information. At step 1234, the organization segments, related elements, and build parameters are received to form the iteration vision and set of deliverables.

Steps 1230 and 1234 then lead into process area 3 1202D. Information from process area 2 1202C is utilized to build the business and technical environment elements at step 1236. Once the client needs are identified, an iteration vision and set of deliverables is documented (step 1234), and the needs are linked to the relevant business and technical environment uses (step 1216), the associated organization segments are built accordingly. In some embodiments, only the necessary elements and necessary element attributes are built so that all effort enables benefit. Future iterations may involve revisiting and enhancing the same elements and segments to accommodate additional uses. At step 1238, the business and technical environment elements from step 1236 are utilized to create a business and technical environment model. After creation of the model, as shown by the multiple process area 1202G, a client may review various portions of the model and/or information to ensure accurateness. The multiple process area 1202G will be described in further detail below.

Once the environment is modeled and built, the flow diagram 1200 proceeds to process area 4 1202E. Process area 4 1202E provides useful information related to the environment information and relationships designed and built in process areas 1-3 1202B-1202D. The output of the environment to reports is what realizes each use and mitigates each need. Numerous reports (e.g., implementation model report, business information report, etc.) may be generated at step 1242 from the report database created at step 1240. The database is maintained and updated by a business and technical environment tool utilized in process area 3 1202D. The information relevant to each use is exported to a set of repository files from which the reports are generated. Information from the database and the reports may also be utilized in the multiple process area 1202G for review and feedback purposes.

The reports and information from the database may also be utilized by process area 5 1202F. Process area 5 1202F allows for the correlation of the business and technical environment reports to client needs. Process area 5 is a transitional stage that completes the current iteration and launches the next iteration. The current iteration is completed with a postmortem examination at step 1244. The postmortem examination evaluates the reports of the current iteration in light of the needs the current iteration is designed to meet and the value that is designed to be delivered. The reports are weighed against the iteration vision and set of deliverables documented at step 1234. Based on iteration decisions and the possibility of additional client needs, another iteration may be activated as shown through the feedback loop from step 1246 to step 1226.

As previously mentioned, the multiple process area 1202G may be enacted during various portions of the flow diagram 1200. Various models, reports, information, etc., as derived from steps 1238, 1240, and 1242, may be reviewed at step 1248. After review, at step 1250, a client or other participant in the organization or process area may determine whether the information or model is approved, or if additional changes should be made. If the model or information is approved, then the review is ended at step 1252. If changes or feedback are necessary, then, at step 1254, feedback is provided to the build elements step 1236. The feedback may be utilized to modify, correct, add, etc. various elements of the model.

It is thus believed that the operation and construction of embodiments of the present invention will be apparent from the foregoing description. While the method and apparatus shown or described have been characterized as being preferred it will be obvious that various changes and modifications may be made therein without departing from the spirit and scope of the invention.

What is claimed is:

1. A system for aiding in an outsourcing environment, the system comprising:
an enterprise description language for describing outsourcing arrangements; and
a knowledge repository for storing modules related to the outsourcing arrangements and storing data related to relationships between the modules.

2. The system of claim 1, further comprising:
means for creating relationships between the modules.

3. The system of claim 1, further comprising:
means for enabling an iteration of the enterprise description language.

4. The system of claim 1, wherein the modules comprise at least one of a solution module, architecture module, information module, operations module, compliance module, strategy module, finance module, users and usage module, workflow module, business module, and change management module.

5. The system of claim 4, wherein the solution module represents an amalgamation of solutions employed to execute an organization's activities in accordance with specified requirements.

6. The system of claim 4, wherein the change module categorizes concepts that involve a change within an organization.

7. The system of claim 4, wherein the strategy module defines a direction that an organization intends to take.

8. The system of claim 4, wherein the change management module describes changes between a current direction of an organization and a desired direction of the organization.

9. The system of claim 4, wherein the finance module describes revenue gained and money consumed by conducting business at an organization.

10. The system of claim 4, wherein the information module represents data an organization uses to conduct business and relationships that exist between various data and systems of record.

11. The system of claim 4, wherein the compliance module describes dimensions of definition that cut across a plurality of items within the enterprise description language.

12. The system of claim 4, wherein the workflow module combines business processes and business process activities that enable features and deliver on functions.

13. The system of claim 4, wherein the business module lays out a business and support functions of an organization and capabilities of the organization that realize the business and support functions.

14. The system of claim 4, wherein the operations module describes a portion of the enterprise description language that details a set of products that enable delivery of business activities.

15. The system of claim 4, wherein the architecture module describes a logical layer and a physical layer that supports business processes of an organization.

16. The system of claim 4, wherein the users and usage module comprises at least one of a business unit director module, application developer module, chief information officer module, chief financial officer module, chief operations officer module, chief technology officer module, data architect module, project manager officer module, project manager module, quality assurance director module, and vendor module.

17. A method for implementing an enterprise description language, the method comprising the steps of:
correlating client needs to business and technical environment uses within an organization;
enacting an iteration of the enterprise description language;
designing organization segments and related elements according to the iteration; and
building organization segments and related elements according to the iteration.

18. The method of claim 17, further comprising the step of organizing iterations of the enterprise description language from more critical to less critical in nature

19. The method of claim 17, wherein the step of correlating further comprises reviewing the business and technical environment uses.

20. The method of claim 17, further comprises the step of forming an iteration vision and set of deliverables.

21. The method of claim 20, wherein the iteration vision and set of deliverables are formed from the organization segments, the related elements, and the building organization segments.

22. The method of claim 17, further comprises the step of generating at least one report regarding the organization elements.

23. The method of claim 22, further comprising the step of:
correlating the at least one report to the client needs; and
weighing the at least one report in view of an iteration vision and set of deliverables.

24. The method of claim 17, further comprising the steps of:
determining if an additional iteration is necessary; and
enacting the additional iteration if it is determined that the additional iteration is necessary.

25. A system for implementing an enterprise description language, the system comprising:
means for correlating client needs to business and technical environment uses within an organization;
means for enacting an iteration of the enterprise description language;
means for designing organization segments and related elements according to the iteration; and
means for building organization segments and related elements according to the iteration.

26. The system of claim 25, further comprises means for organizing iterations of the enterprise description language from more critical to less critical in nature.

27. The system of claim 25, wherein the means for correlating further comprises means for reviewing the business and technical environment uses.

28. The system of claim 25, further comprises means for forming an iteration vision and set of deliverables.

29. The system of claim 28, wherein the iteration vision and set of deliverables are formed from the organization segments, the related elements and the building organization segments.

30. The system of claim 25, further comprises means for generating at least one report regarding the regarding the organization elements.

31. The system of claim 30, further comprising:
means for correlating the at least one report to the client needs; and
means for weighing the at least one report in view of an iteration vision and set of deliverables.

32. The system of claim 25, further comprising:
means for determining if an additional iteration is necessary; and
means for enacting the additional iteration if it is determined that the additional iteration is necessary.
